(19) United States
(12) Patent Application Publication
(10) Pub. No.: US 2022/0343698 A1
(43) Pub. Date: Oct. 27, 2022

(54) INSPECTION ASSISTANCE PROGRAM, INSPECTION ASSISTANCE SYSTEM, AND INSPECTION ASSISTANCE APPARATUS CONTROL METHOD

(71) Applicant: ISUZU MOTORS LIMITED, Tokyo (JP)

(72) Inventors: Akira IMAI, Fujisawa-shi, Kanagawa (JP); Hideto HIRAHARA, Fujisawa-shi, Kanagawa (JP)

(21) Appl. No.: 17/618,272

(22) PCT Filed: Jun. 11, 2020
(86) PCT No.: PCT/JP2020/023013

§ 371 Date: Dec. 10, 2021

(30) Foreign Application Priority Data
Jun. 13, 2019 (JP) 2019-110529

(51) Int. Cl. G07C 5/00; G07C 5/08; G01M 17/007

(52) U.S. Cl. CPC G07C 5/008; G07C 5/0808; G07C 5/0825; G01M 17/007

(57) ABSTRACT

A program for supporting inspection of a vehicle causes a computer to function as: a detection information obtainment unit 251 that obtains, from a control device of the vehicle detecting an operation to an operation part mounted on the vehicle, detection information indicating that the operation to the operation part is detected; a confirmation result reception unit 253 that receives an input of a confirmation result of a state of equipment of the vehicle in which the state changes in accordance with the operation to the operation part; and a determination unit 254 that determines that there is no abnormality in the operation part, on condition that the detection information obtainment unit 251 normally obtains the detection information and that the confirmation result received by the confirmation result reception unit 253 indicates that there is no abnormality.

### TECHNICAL FIELD

The present disclosure relates to an inspection support program, an inspection support system, and a control method for an inspection support device that support inspection of a vehicle.

### BACKGROUND ART

A user of a commercial vehicle such as a truck needs to perform pre-operation inspection every day. A related-art vehicle inspection support device displays an input screen for inputting an inspection result of pre-operation inspection (for example, Patent Literature 1).

### CITATION LIST

### Patent Literature

Patent Literature 1: JP-A-2007-118887

### SUMMARY OF INVENTION

### Technical Problem

In the related-art vehicle inspection support device disclosed in Patent Literature 1, in order to inspect a state of equipment of a vehicle such as a brake lamp, two operators are required, one of whom depresses a brake pedal in a cab and the other inspects a state of being turned on or turned off of the brake lamp outside the vehicle.

The present disclosure has been made in view of this point, and an object of the present disclosure is to provide an inspection support program and an inspection support system that can reduce the number of operators required for inspection of a vehicle.

### Solution to Problem

An inspection support program according to a first illustrative aspect of the present disclosure is a program for supporting inspection of a vehicle which causes a computer to function as: a detection information obtainment unit that obtains, from a control device of the vehicle detecting an operation to an operation part mounted on the vehicle, detection information indicating that the operation to the operation part is detected; a confirmation result reception unit that receives an input of a confirmation result of a state of equipment of the vehicle, the state changing in accordance with the operation to the operation part; and a determination unit that determines that there is no abnormality in the operation part, on condition that the detection information obtainment unit normally obtains the detection information and that the confirmation result received by the confirmation result reception unit indicates that there is no abnormality.

The confirmation result reception unit may receive the input of the confirmation result after the detection information obtainment unit obtains the detection information. The detection information obtainment unit may obtain the detection information from the control device of the vehicle by a wireless communication.

It may further cause the computer to function as: a display control unit configured to: in a case the wireless communication with the control device of the vehicle is established, control a display unit to display that an operation is to be performed in a first mode, in which it is determined that there is no abnormality in the operation part based on the detection information and the confirmation result; and in a case the wireless communication with the control device of the vehicle is not established, control the display unit to display that an operation is to be performed in a second mode, in which it is determined that there is no abnormality in the operation part based on the confirmation result.

It may further cause the computer to function as: a transmission control unit configured to transmit, to the control device of the vehicle, instruction information for changing the state of the equipment of the vehicle. It may further cause the computer to function as: a display control unit configured to control a display unit to display a screen including an instruction image for instructing transmission of the instruction information and an input image for inputting the confirmation result. It may further cause the computer to function as: an operation reception unit that receives an operation of instructing start of inspection, wherein the determination unit determines that the detection information is normally obtained in a case the detection information is obtained within predetermined time since the operation reception unit receives the operation of instructing start of inspection. Before the detection information is obtained by the detection information obtainment unit, the determination unit may determine that the detection information is not normally obtained in a case the confirmation result reception unit receives an operation of instructing transition from a screen being displayed to another screen.

An inspection support system according to a second illustrative aspect of the present disclosure is an inspection support system for supporting inspection of a vehicle, the inspection support system including: an inspection support device; and a control device of the vehicle, wherein the control device includes: a detection unit configured to detect whether an operation part mounted on the vehicle is operated; and a transmission control unit configured to, when an operation to the operation part is detected, transmit detection information to the inspection support device, the detection information indicating that the operation to the operation part is detected, and wherein the inspection support device includes: a detection information obtainment unit that obtains the detection information; a confirmation result reception unit that receives an input of a confirmation result of a state of equipment of the vehicle, the state changing in accordance with the operation to the operation part; and a determination unit configured to determine that there is no abnormality in the operation part, on condition that the detection information obtainment unit normally obtains the detection information and that the confirmation result received by the confirmation result reception unit indicates that there is no abnormality.

A control method for an inspection support device according to a third illustrative aspect of the present disclosure is a control method for an inspection support device for supporting inspection of a vehicle, the control method including causing the inspection support device to perform: obtaining, from a control device of the vehicle that detects an operation to an operation part mounted on the vehicle, detection information indicating that the operation to the operation part is detected; receiving an input of a confirmation result of a state of equipment of the vehicle, the state changing in accordance with the operation to the operation part; and determining that there is no abnormality in the operation part, on condition that the detection information is normally obtained and that the confirmation result in the reception indicates that there is no abnormality.

A still another illustrative aspect of the present disclosure is a computer-readable medium storing an inspection support program for supporting inspection of a vehicle readable by a computer, the inspection support program, when executed by the computer, causing the inspection support device to perform: obtaining, from a control device of the vehicle that detects an operation to an operation part mounted on the vehicle, detection information indicating that the operation to the operation part is detected; receiving an input of a confirmation result of a state of equipment of the vehicle, the state changing in accordance with the operation to the operation part; and determining that there is no abnormality in the operation part, on condition that the detection information is normally obtained and that the confirmation result in the reception indicates that there is no abnormality.

### Advantageous Effects of Invention

According to the present disclosure, an effect is achieved that it is possible to reduce the number of operators required for inspection of a vehicle.

### BRIEF DESCRIPTION OF DRAWINGS

FIG. 1 is a diagram illustrating a configuration of an inspection support system according to an embodiment.

FIG. 2 is a diagram illustrating a screen that is displayed by an inspection support device immediately after an inspection application is started.

FIG. 3 is a diagram illustrating a configuration of a vehicle.

FIG. 4 is a diagram illustrating a configuration of the inspection support device.

FIG. 5A is a diagram illustrating an example of a screen displayed on a display unit by a display control unit.

FIG. 5B is a diagram illustrating another example of a screen displayed on the display unit by the display control unit.

FIG. 6 is a diagram illustrating an example of a screen displayed on the display unit by the display control unit.

FIG. 7 is a flowchart illustrating a processing procedure of determining an abnormality of equipment of the vehicle by the inspection support device.

### DESCRIPTION OF EMBODIMENTS

[Overview of Inspection Support System]

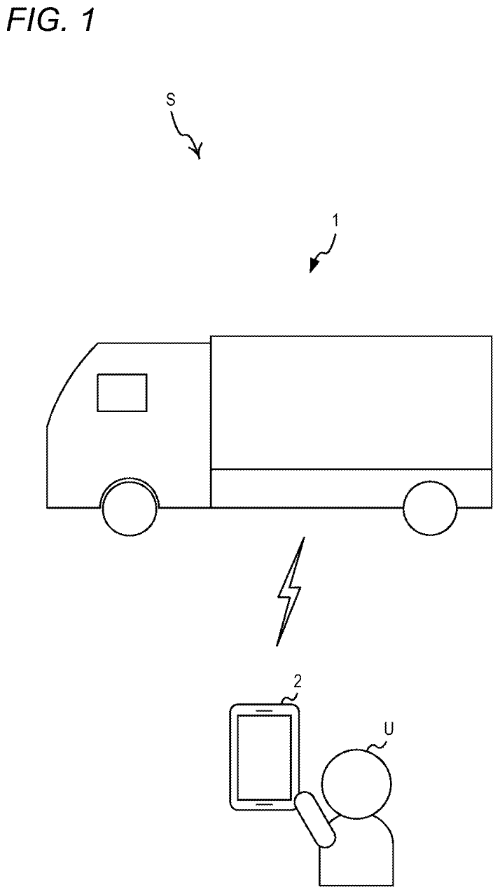

FIG. 1 is a diagram illustrating a configuration of an inspection support system S according to an embodiment. The inspection support system S includes an inspection support device 2 for supporting inspection of a vehicle 1. The vehicle 1 is a commercial vehicle, and is, for example, a truck. The inspection support device 2 is a device managed by a business operator who inspects the vehicle 1, and is, for example, an information terminal such as a smartphone or a tablet.

The inspection support device 2 displays, on a display, an inspection item and an inspection method for pre-operation inspection of the vehicle 1 when an inspection application software (hereinafter, referred to as an “inspection application”) is started. The inspection support device 2 receives an operation of a user U who inputs an inspection result.

The inspection support device 2 communicates with the vehicle 1 by wireless communication via an in-vehicle wireless device mounted on the vehicle 1. For example, the inspection support device 2 communicates with the vehicle 1 by Wi-Fi (registered trademark) or Bluetooth (registered trademark). The inspection support device 2 transmits, for example, instruction information for changing a state of equipment of the vehicle 1 to the vehicle 1 by wireless communication.

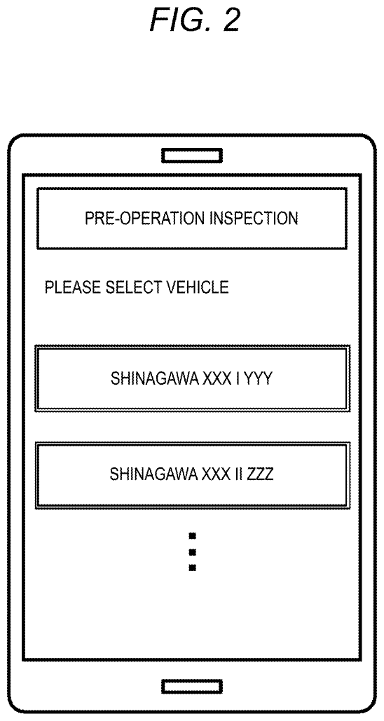

FIG. 2 is a diagram illustrating a screen that is displayed by the inspection support device 2 immediately after the inspection application is started. As illustrated in FIG. 2, the inspection support device 2 first displays a screen for selecting the vehicle 1 that is to be subjected to pre-operation inspection. In the example of FIG. 2, an operation key for selecting a vehicle with vehicle registration information of “Shinagawa XXX I YYY” and an operation key for selecting a vehicle with vehicle registration information of “Shinagawa XXX II ZZZ” are displayed. The vehicle registration information is information for identifying a vehicle. The vehicle registration information is registered in advance by an administrator of the inspection support system S.

When an operation for selecting the vehicle 1 is performed in the screen of FIG. 2, an inspection item necessary for the selected vehicle 1 is displayed. The user U performs inspection corresponding to the displayed inspection item, and inputs an inspection result to the inspection support device 2. Details of a mode in which the inspection support device 2 displays inspection items will be described later.

[Configuration of Vehicle]

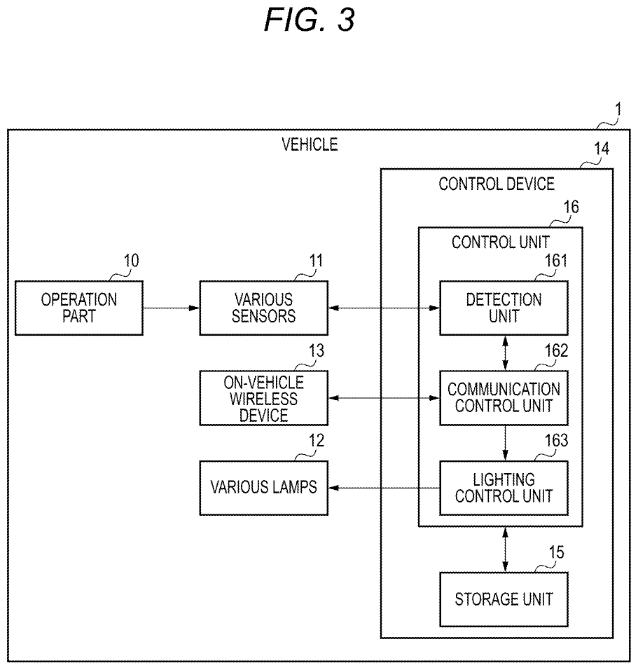

FIG. 3 is a diagram illustrating a configuration of the vehicle 1. The vehicle 1 includes an operation part 10, various sensors 11, various lamps 12, an in-vehicle wireless device 13, and a control device 14. The control device 14 includes a storage unit 15 and a control unit 16.

The operation part 10 is operated by a user to cause the vehicle 1 to travel. The operation part 10 is, for example, a brake pedal, a transmission, or the like. The various sensors 11 detect that the operation part of the vehicle 1 is operated. The various sensors 11 include, for example, a sensor for detecting depression of the brake pedal, a sensor for detecting that a gear is put into reverse by the transmission, and the like. The various lamps 12 include equipment such as a brake lamp and a backlight.

The in-vehicle wireless device 13 is a device for communicating with the inspection support device 2 by wireless communication. The in-vehicle wireless device 13 transmits information, which is notified from the control unit 16, to the inspection support device 2. In addition, the in-vehicle wireless device 13 notifies the control unit 16 of information received from the inspection support device 2. The in-vehicle wireless device 13 may transmit the information, which is notified from the control unit 16, to a device other than the inspection support device 2 (for example, a server).

The control device 14 is, for example, an electronic control unit (ECU). The control device 14 electronically controls each part of the vehicle 1 by a computer. The storage unit 15 is configured by, for example, a read only memory (ROM), a random access memory (RAM), and the like. The storage unit 15 stores various programs and various types of data for causing the control unit 16 to function. The storage unit 15 may be a computer-readable storage medium.

The control unit 16 functions as a detection unit 161, a communication control unit 162, and a lighting control unit 163 by executing a program stored in the storage unit 15. The detection unit 161 detects whether the operation part 10 mounted on the vehicle 1 is operated, based on a detection result of the various sensors 11. The detection unit 161 detects, for example, whether the brake pedal is depressed. When it is detected that the operation part 10 is operated, the detection unit 161 generates detection information indicating that the operation is detected.

The communication control unit 162 communicates with the inspection support device 2 via the in-vehicle wireless device 13. The communication control unit 162 transmits the detection information, which indicates that the operation of the operation part 10 is detected by the detection unit 161, to the inspection support device 2. For example, the communication control unit 162 first receives, from the inspection support device 2, inquiry information for confirming whether it is detected that the operation part 10 is operated. The communication control unit 162 transmits the detection information to the inspection support device 2 in response to the received inquiry information. In addition, the communication control unit 162 may transmit the detection information to the inspection support device 2 each time the operation of the operation part 10 is detected by the detection unit 161, without receiving the inquiry information.

The communication control unit 162 receives instruction information for changing a state of equipment of the vehicle from the inspection support device 2. The communication control unit 162 notifies the lighting control unit 163 of the received instruction information. The lighting control unit 163 changes the state of equipment of the vehicle in accordance with the instruction information received by the communication control unit 162. For example, the lighting control unit 163 turns on or turns off the various lamps 12 as equipment of the vehicle.

[Inspection Support Device]

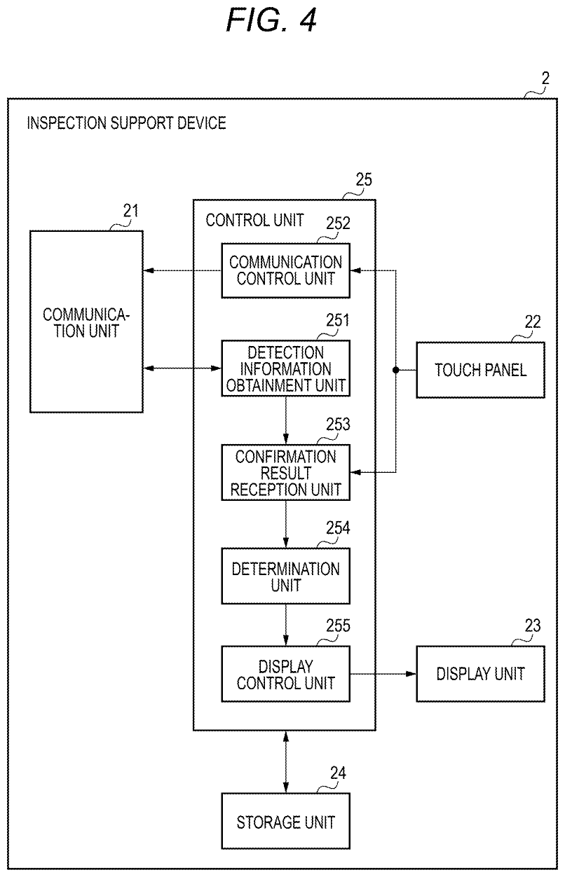

FIG. 4 is a diagram illustrating a configuration of the inspection support device 2. The inspection support device 2 includes a communication unit 21, a touch panel 22, a display unit 23, a storage unit 24, and a control unit 25. The communication unit 21 is a communication module for performing wireless communication with the control device 14 of the vehicle 1. The communication unit 21 communicates with the control device 14 of the vehicle 1 via, for example, Wi-Fi (registered trademark) communication.

The touch panel 22 detects a user's operation by a touch sensor formed on the display unit 23. The display unit 23 is a display that displays an image. The storage unit 24 is configured by, for example, a ROM, a RAM, and the like. The control unit 25 functions as a detection information obtainment unit 251, a communication control unit 252, a confirmation result reception unit 253, a determination unit 254, and a display control unit 255 by executing a program stored in the storage unit 24.

The detection information obtainment unit 251 obtains the detection information, which indicates that it is detected that the operation part 10 is operated, from the control device 14 of the vehicle 1 via the communication unit 21. The detection information obtainment unit 251 obtains the detection information from the control device 14 by wireless communication such as Wi-Fi, for example. In order to obtain the detection information, the detection information obtainment unit 251 transmits, for example, inquiry information for confirming whether it is detected that the operation part 10 is operated, to the control device 14 of the vehicle 1. After transmitting the inquiry information, the detection information obtainment unit 251 obtains the detection information from the control device 14.

The communication control unit 252 transmits instruction information for changing a state of equipment of the vehicle 1 to the control device 14 of the vehicle 1 via the communication unit 21. For example, when a user's instruction to turn on the brake lamp is received by the touch panel 22, the communication control unit 252 transmits instruction information for turning on the brake lamp to the control device 14 of the vehicle 1. With such a configuration, the communication control unit 252 can instruct the control device 14 of the vehicle 1 to turn on the brake lamp or the like from the outside of the vehicle. Therefore, the user can easily inspect the brake lamp and the like.

The confirmation result reception unit 253 receives an input of a confirmation result of a state of equipment of the vehicle 1, in which the state changes in accordance with the operation to the operation part 10. For example, in the pre-operation inspection of the vehicle 1, when the lighting control unit 163 generates a control signal for turning on the brake lamp, the user confirms whether the brake lamp at the rear portion of the vehicle 1 is turned on without abnormality, and operates the touch panel 22 to input a confirmation result. The confirmation result reception unit 253 receives the input of the confirmation result.

The user can confirm whether the various lamps 12 of the vehicle 1 are turned on without abnormality when the lighting control unit 163 generates a control signal for turning on the various lamps 12. However, in this procedure, the user is not able to confirm whether the detection unit 161 detects without abnormality that the operation part 10 is operated.

Therefore, the confirmation result reception unit 253 first confirms, in the detection information obtainment unit 251, whether the detection unit 161 detects without abnormality that the operation part 10 is operated. After the detection information obtainment unit 251 obtains detection information, the confirmation result reception unit 253 receives the input of the confirmation result. On the other hand, before the detection information obtainment unit 251 obtains the detection information, the confirmation result reception unit 253 does not receive the input of the confirmation result. With such a configuration, when it is determined that the detection unit 161 detects the operation of the operation part 10 without abnormality, the user can confirm whether there is no abnormality in the equipment whose state is changed by the operation.

[Determination of Abnormality of Equipment]

When both of the following first and second conditions are satisfied, the determination unit 254 determines that there is no abnormality in the operation part 10. First, as the first condition, the determination unit 254 determines whether the detection information obtainment unit 251 normally obtains the detection information. In order to determine the first condition, the determination unit 254 obtains a start time-point at which an operation reception unit (not illustrated) receives, by the touch panel 22, an operation for instructing start of inspection, and an obtainment time-point at which the detection information obtainment unit 251 obtains the detection information.

When time from the start time-point to the obtainment time-point is within predetermined time, the determination unit 254 determines that the detection information is normally obtained. The predetermined time is a value assumed as time required for the user to operate the operation part 10. On the other hand, when the time from the start time-point to the obtainment time-point exceeds the predetermined time, the determination unit 254 determines that the detection information obtainment unit 251 does not normally obtain the detection information.

In addition, it is not limited to the example in which the determination unit 254 determines that the detection information is normally obtained when the time from the start time-point to the obtainment time-point is within the predetermined time. For example, when the detection information is obtained by the detection information obtainment unit 251, the determination unit 254 may determine that the detection information is normally obtained, regardless of whether the time from the start time-point to the obtainment time-point is within the predetermined time.

Before the detection information is obtained by the detection information obtainment unit 251, the determination unit 254 may interrupt the obtainment of the detection information performed by the detection information obtainment unit 251 when the confirmation result reception unit 253 receives a user's operation of instructing transition from a screen being displayed to another screen. When the obtainment of the detection information is interrupted, the determination unit 254 may determine that the detection information is not normally obtained.

As the second condition, the determination unit 254 refers to the confirmation result received by the confirmation result reception unit 253, and determines whether there is no abnormality in a confirmation target place. For example, when the confirmation result reception unit 253 receives an input of a confirmation result indicating that there is no abnormality in equipment whose state is changed by the operation of the operation part 10, the determination unit 254 determines that there is no abnormality in the confirmation target place. On the other hand, when the confirmation result reception unit 253 receives an input of a confirmation result indicating that there is an abnormality in equipment, the determination unit 254 determines that there is an abnormality in the confirmation target place. Hereinafter, an operation of determining whether there is an abnormality in equipment based on both the detection information and the confirmation result by the determination unit 254 is referred to as a first mode.

[Change of Mode]

When wireless communication with the control device 14 of the vehicle 1 is established, the determination unit 254 determines whether there is an abnormality in the operation part 10 in the first mode. On the other hand, when the wireless communication with the control device 14 of the vehicle 1 is not established, the detection information obtainment unit 251 cannot obtain detection information. Therefore, the determination unit 254 cannot determine whether there is an abnormality in the first mode.

Therefore, when the wireless communication with the control device 14 of the vehicle 1 is not established, the determination unit 254 determines whether there is an abnormality in the operation part 10 based on a confirmation result received by the confirmation result reception unit 253 without using the detection information for determination (hereinafter, the operation of determining whether there is an abnormality in equipment based on the confirmation result by the determination unit 254 is referred to as a second mode). In the second mode, it is assumed that inspection is performed by a plurality of users. For example, in a case where users perform an inspection item “inspection of brake lamp”, when one user operates the brake pedal, another user confirms whether there is no abnormality in turning-on of the brake lamp, and operates the touch panel 22 to input a confirmation result. The determination unit 254 determines whether there is an abnormality in the brake lamp based on the confirmation result.

[Example of Execution Screen]

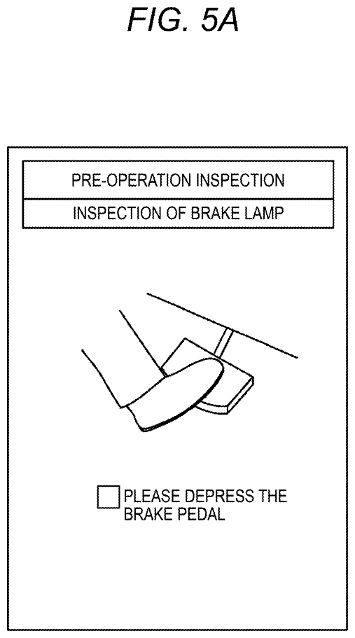

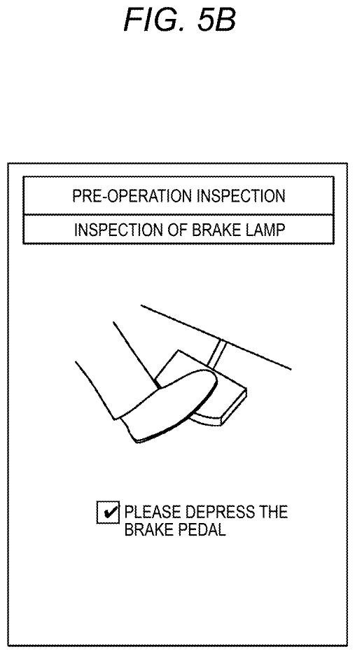

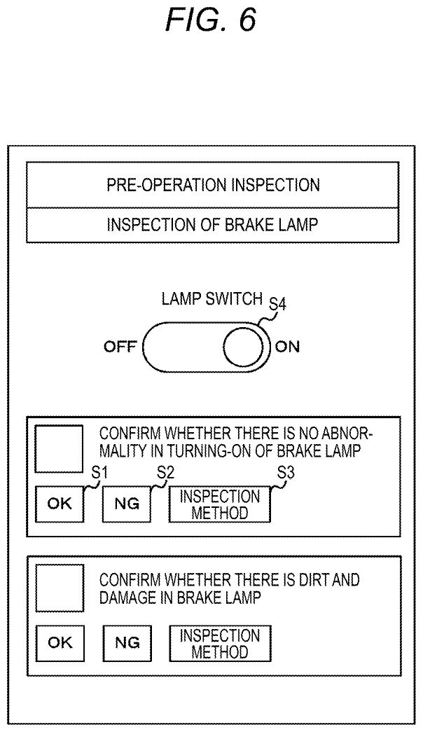

The display control unit 255 performs display control of the display unit 23. FIGS. 5A, 5B, and 6 are diagrams illustrating examples of screens displayed on the display unit 23 by the display control unit 255. FIGS. 5A and 5B illustrate screens displayed on the display unit 23 when the user executes the inspection item “inspection of brake lamp”. In a state illustrated in FIG. 5A, the detection information obtainment unit 251 does not obtain detection information indicating that the brake pedal is operated as the operation part 10. In the state of FIG. 5A, the confirmation result reception unit 253 does not receive an input of a confirmation result regarding an inspection item “whether there is no abnormality in turning-on of the brake pedal”.

On the other hand, FIG. 5B illustrates an execution screen presented after the detection information obtainment unit 251 obtains the detection information indicating that the brake pedal is operated. When the detection information obtainment unit 251 obtains the detection information, the state of FIG. 5A automatically transitions to a state of FIG. 5B. In FIG. 5B, a check mark indicating that the detection information is obtained by the detection information obtainment unit 251 is automatically assigned to a rectangular display field corresponding to the inspection item “inspection of brake lamp”. When the confirmation result reception unit 253 detects a tap operation of the user on the touch panel 22 in the state of FIG. 5B, the execution screen of FIG. 6 is displayed.

The display control unit 255 does not perform screen transition until the detection unit 161 detects that the brake pedal is operated. In the state of FIG. 5A, the detection unit 161 does not detect that the brake pedal is operated. Therefore, when the confirmation result reception unit 253 detects a tap operation of the user on the touch panel 22 in the state of FIG. 5A, the display control unit 255 does not perform transition to the execution screen of FIG. 6.

However, it is not limited to the example in which the display control unit 255 does not perform the transition to the execution screen in the state of FIG. 5A. When the confirmation result reception unit 253 detects a tap operation of the user on the touch panel 22 in the state of FIG. 5A, the display control unit 255 may perform transition to the execution screen of FIG. 6. When the confirmation result reception unit 253 detects a tap operation in the state of FIG. 5A, the determination unit 254 may determine that the detection information is not normally obtained.

In FIG. 6, a plurality of inspection items related to the brake lamp are displayed. The confirmation result reception unit 253 receives an input of a confirmation result regarding the inspection item “whether there is no abnormality in turning-on of brake lamp” in the execution screen of FIG. 6.

In the execution screen of FIG. 6, an “OK” key S1, an “NG” key S2, an “inspection method” key S3, and a lamp switch S4 are displayed. The “OK” key S1 and the “NG” key S2 are input images for inputting a confirmation result. The “OK” key S1 is used to input that no abnormality is found in inspection of a corresponding inspection item. The “NG” key S2 is used to input that an abnormality is found in inspection of a corresponding inspection item. The “inspection method” key S3 is used to display a specific method of inspection and a criterion for determination of an abnormality.

The lamp switch S4 is an instruction image for changing a state of equipment of the vehicle such as the brake lamp. When the lamp switch S4 is operated by the user, instruction information for turning on or turning off the brake lamp is transmitted to the control device 14 by the communication control unit 162.

The display control unit 255 causes the display unit 23 to display the execution screen including an instruction image such as the lamp switch S4 for instructing transmission of instruction information and an input image such as the “OK” key S1 for inputting a confirmation result, as illustrated in FIG. 6. With such a configuration, the execution screen is configured such that the display control unit 255 receive both the lamp turning-on operation and the input of the confirmation result in the same execution screen, and thus it is possible to improve the operability.

[Display of Mode]

When wireless communication with the control device 14 of the vehicle 1 is established, the display control unit 255 causes the display unit 23 to display that the operation of the first mode is to be performed. For example, the display control unit 255 displays a message indicating that the operation of the first mode is to be performed.

When wireless communication with the control device 14 of the vehicle 1 is not established, the display control unit 255 may cause the display unit 23 to display that the operation of the second mode is to be performed. In the second mode, inspection is performed by a plurality of users. For this reason, when wireless communication with the control device 14 of the vehicle 1 is not established, the display control unit 255 may display a message indicating that a plurality of users are required to perform the inspection together with a message indicating that the operation of the second mode is to be performed.

When detection information obtainment unit 251 does not normally obtain detection information, the display control unit 255 causes the display unit 23 to display a message notifying that the detection information cannot be obtained. After the confirmation result reception unit 253 receives confirmation results of all the inspection items of the pre-operation inspection, the display control unit 255 displays a list of determination results of the determination unit 254 for some or all of the inspection items.

[Processing Procedure of Abnormality Determination]

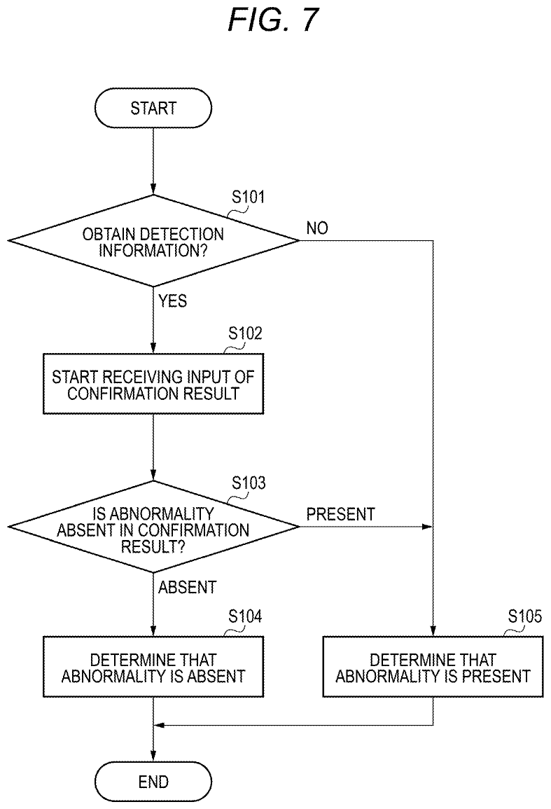

FIG. 7 is a flowchart illustrating a processing procedure of determining an abnormality of equipment of the vehicle 1 by the inspection support device 2. This processing procedure is started when, for example, the detection information obtainment unit 251 transmits, to the control device 14 of the vehicle 1, inquiry information for confirming whether it is detected that the operation part 10 is operated.

First, the confirmation result reception unit 253 determines whether the detection information obtainment unit 251 normally obtains detection information from the control device 14 of the vehicle 1 (S101). When it is determined that the detection information obtainment unit 251 normally obtains the detection information (YES in S101), the confirmation result reception unit 253 starts reception of an input of a confirmation result (S102).

The determination unit 254 determines whether the confirmation result received by the confirmation result reception unit 253 indicates that there is no abnormality in the equipment of the vehicle 1 (S103). When the confirmation result received by the confirmation result reception unit 253 indicates that there is no abnormality in the equipment of the vehicle 1 (S103: “ABSENT”), the determination unit 254 determines that there is no abnormality in the equipment of the vehicle 1 with respect to the inspection item corresponding to the confirmation result (S104), and ends the processing.

When the detection information obtainment unit 251 does not normally obtain the detection information in the determination of S101 (NO in S101), the confirmation result reception unit 253 determines that there is an abnormality in the equipment with respect to the corresponding inspection item (S105), and ends the processing. When the confirmation result indicates that there is an abnormality in the equipment of the vehicle 1 in the determination of S103 (S103: “PRESENT”), the determination unit 254 determines that there is an abnormality in the equipment of the vehicle 1 with respect to the inspection item corresponding to the confirmation result (S105), and ends the processing.

[Effects of Present Disclosure]

According to the present embodiment, the determination unit 254 determines that there is no abnormality in the operation part 10, on condition that the detection information obtainment unit 251 obtains the detection information normally and that the confirmation result received by the confirmation result reception unit 253 indicates that there is no abnormality. With such a configuration, the display control unit 255 can gradually advance inspection of whether it is detected normally that the operation part 10 is operated and inspection of whether there is an abnormality in a change of a state of equipment in accordance with the operation to the operation part 10. Therefore, it is not necessary to divide the labor of performing the operation of the operation part 10 and the confirmation of the change in the state of the equipment among a plurality of users. Therefore, the number of users required for the inspection of the vehicle can be reduced.

In the present embodiment, an example of a case in which the detection information obtainment unit 251, the communication control unit 252, the confirmation result reception unit 253, the determination unit 254, and the display control unit 255 in FIG. 4 are mounted on the inspection support device 2 is described. However, the present disclosure is not limited thereto. For example, the inspection support device 2 may be connected to a management server (not illustrated) by wireless communication, and functional blocks such as the detection information obtainment unit 251 may be implemented on the management server. The management server may be a single server or a cloud server including a plurality of servers.

Although the present invention has been described above using the embodiment, the technical scope of the present invention is not limited to the scope described in the above embodiment, and various modifications and changes can be made within the scope of the gist of the present invention. For example, all or some of the devices may be functionally or physically distributed or integrated in any unit. Further, new embodiments generated by any combination of a plurality of embodiments are also contained in the embodiment of the present invention. Effects of the new embodiments generated by the combination include effects of the original embodiment.

The present application is based on the Japanese Patent Application No. 2019-110529 filed on Jun. 13, 2019, and contents thereof are incorporated herein as reference.

### INDUSTRIAL APPLICABILITY

The present invention has an effect of reducing the number of operators required for inspection of a vehicle and is useful in, for example, an inspection support program, an inspection support system, and a control method for an inspection support device that support the inspection of the vehicle.

### REFERENCE SIGNS LIST

1 Vehicle
2 Inspection support device
11 Various sensors
12 Various lamps
13 In-vehicle wireless device
14 Control device
15 Storage unit
16 Control unit
21 Communication unit
22 Touch panel
23 Display unit
24 Storage unit
25 Control unit
161 Detection unit
162 Communication control unit
251 Detection information obtainment unit
252 Communication control unit
253 Confirmation result reception unit
254 Determination unit
255 Display control unit

1. A non-transitory computer-readable medium storing
an inspection support program for supporting inspection of a vehicle readable by a computer, the inspection support program, when executed by the computer, causing the computer to perform:
obtaining, from a control device of the vehicle detecting an operation to an operation part mounted on the vehicle, detection information indicating that the operation to the operation part is detected;
receiving an input of a confirmation result of a state of equipment of the vehicle, the state changing in accordance with the operation to the operation part; and
determining that there is no abnormality in the operation part, on condition that the detection information is normally obtained and that the received confirmation result indicates that there is no abnormality.

2. The non-transitory computer-readable medium according to claim 1, wherein in the receiving of the input, the inspection support program, when executed by the computer, causes the computer to perform:
receiving the input of the confirmation result after obtaining the detection information.

3. The non-transitory computer-readable medium according to claim 1, wherein in the obtaining of the detection information, the inspection support program, when executed by the computer, causing the computer to perform:
obtaining the detection information from the control device of the vehicle by a wireless communication.

4. The non-transitory computer-readable medium according to claim 3, wherein the inspection support program, when executed by the computer, further causes the computer to perform:
in a case the wireless communication with the control device of the vehicle is established, controlling a display unit to display that an operation is to be performed in a first mode, in which it is determined that there is no abnormality in the operation part based on the detection information and the confirmation result; and
in a case the wireless communication with the control device of the vehicle is not established, controlling the display unit to display that an operation is to be performed in a second mode, in which it is determined that there is no abnormality in the operation part based on the confirmation result.

5. The non-transitory computer-readable medium according to claim 3, wherein the inspection support program, when executed by the computer, further causes the computer to perform:
transmitting, to the control device of the vehicle, instruction information for changing the state of the equipment of the vehicle.

6. The non-transitory computer-readable medium according to claim 5, wherein the inspection support program, when executed by the computer, further causes the computer to perform:
controlling a display unit to display a screen including an instruction image for instructing transmission of the instruction information and an input image for inputting the confirmation result.

7. The non-transitory computer-readable medium according to claim 1,
wherein the inspection support program, when executed by the computer, further causes the computer to perform:
receiving an operation of instructing start of inspection, and
wherein in the determining, the inspection support program, when executed by the computer, causes the computer to perform:
determining that the detection information is normally obtained in a case the detection information is obtained within predetermined time since the receipt of the operation of instructing start of inspection.

8. The non-transitory computer-readable medium according to claim 1, wherein in the determining, the inspection support program, when executed by the computer, causes the computer to perform:
before obtaining the detection information, determining that the detection information is not normally obtained in a case an operation of instructing transition from a screen being displayed to another screen is received.

9. An inspection support system for supporting inspection of a vehicle, the inspection support system comprising:
an inspection support device; and
a control device of the vehicle, the control device being configured to:
detect whether an operation part mounted on the vehicle is operated; and
when an operation to the operation part is detected, transmit detection information to the inspection support device, the detection information indicating that the operation to the operation part is detected, and
wherein the inspection support device comprises a controller configured to:
obtain the detection information;
receive an input of a confirmation result of a state of equipment of the vehicle, the state changing in accordance with the operation to the operation part; and
determine that there is no abnormality in the operation part, on condition that the detection information is normally obtained and that the received confirmation result indicates that there is no abnormality.

10. A control method for an inspection support device for supporting inspection of a vehicle, the control method comprising causing the inspection support device to perform:
obtaining, from a control device of the vehicle that detects an operation to an operation part mounted on the vehicle, detection information indicating that the operation to the operation part is detected;
receiving an input of a confirmation result of a state of equipment of the vehicle, the state changing in accordance with the operation to the operation part; and
determining that there is no abnormality in the operation part, on condition that the detection information is normally obtained and that the confirmation result in the reception indicates that there is no abnormality.
